(19) United States
(12) Patent Application Publication
(10) Pub. No.: US 2015/0357647 A1
(43) Pub. Date: Dec. 10, 2015

(54) BINDER FOR LITHIUM ION SECONDARY BATTERY ELECTRODES, SLURRY, ELECTRODE, AND LITHIUM ION SECONDARY BATTERY

(71) Applicant: SHOWA DENKO K.K., Tokyo (JP)

(72) Inventors: Tomonori KURATA, Tatsuno-shi (JP); Mitsuru HANASAKI, Himeji-shi (JP); Kazunari FUKASE, Himeji-shi (JP)

(73) Assignee: SHOWA DENKO K.K., Tokyo (JP)

(21) Appl. No.: 14/760,647

(22) PCT Filed: Jan. 20, 2014
(86) PCT No.: PCT/JP2014/050935

§ 371 Date: Jul. 13, 2015

(30) Foreign Application Priority Data
Jan. 21, 2013 (JP) 2013-008557

(51) Int. Cl. H01M 4/62; H01M 4/133; H01M 10/0525; H01M 4/131

(52) U.S. Cl. CPC H01M 4/622; H01M 4/131; H01M 4/133; H01M 10/0525; H01M 2004/027

(57) ABSTRACT

The present invention provides a binder for lithium ion secondary battery electrodes that is obtained by emulsion polymerization of an ethylenically unsaturated monomer in an aqueous medium in the presence of a surfactant, the ethylenically unsaturated monomer being composed, with respect to the total mass of the ethylenically unsaturated monomer, of 15% by mass to 70% by mass of styrene, 1% by mass to 10% by mass of an N atom-containing ethylenically unsaturated monomer, 1% by mass to 10% by mass of an ethylenically unsaturated carboxylic acid, 0.1% by mass to 5% by mass of an internal crosslinking agent, and 22% by mass to 82.9% by mass of another ethylenically unsaturated monomer that is copolymerizable with these substances, and has a glass transition temperature of −55° C. to 30° C.

### TECHNICAL FIELD

The present invention relates to a binder for a lithium ion secondary battery electrode used for forming a lithium ion secondary battery electrode, a slurry obtained using the same, an electrode, and a lithium ion secondary battery. Priority is claimed on Japanese Patent Application No. 2013-008557, filed Jan. 21, 2013, the content of which is incorporated herein by reference.

### BACKGROUND ART

Lithium ion secondary batteries have been used as power sources for laptop computers, cellular phones, electric power tools, and electronic and communication devices in terms of reduction in size and weight. In recent years, from the viewpoint of application in environmentally-friendly vehicles, lithium ion secondary batteries have also been used for electric cars and hybrid cars. Among them, there has been a strong demand for lithium ion secondary batteries with high output, high capacity, and long service life.

A lithium ion secondary battery includes an electrode composed of a positive electrode including a metal oxide such as a lithium cobalt oxide as an active material and a negative electrode including a carbon material such as graphite as an active material, and an electrolytic solution including carbonates as a solvent. The lithium ion secondary battery is a secondary battery which is charged and discharged by the movement of lithium ions between the positive electrode and the negative electrode.

The positive electrode is obtained by applying a slurry composed of the active material and a binder onto the surface of a positive electrode current collector such as aluminum foil, drying the slurry, and then cutting the current collector with the slurry into an appropriate size. The negative electrode is obtained by applying a slurry composed of the active material and a binder onto the surface of a negative electrode current collector such as copper foil, drying the slurry, and then cutting the negative electrode current collector into an appropriate size.

Each binder used for the lithium ion secondary battery electrodes has a role of binding the active materials to each other and the active material and the current collector to prevent the active materials from being peeled off from the surface of the current collector.

As such a binder, a polyvinylidene fluoride (PVDF)-based binder with N-methylolpyrrolidone (NMP) as a solvent has been used (for example, refer to PTL 1).

However, the PVDF-based binder has low binding properties between active materials and between an active material and a current collector. Therefore, when the PVDF-based binder is used to manufacture a lithium ion secondary battery electrode, it is necessary to contain a large amount of binder in the slurry. As a result, there has been a disadvantage of decreasing the capacity of the lithium ion secondary battery.

In the PVDF-based binder, NMP, which is an expensive organic solvent, is used as a solvent. Therefore, there has been a problem of an increase in the price of a final product. In addition, in the PVDF-based binder, NMP, which is an organic solvent, is used as a solvent. Therefore, there has also been a problem in working environment conservation in the preparation of a slurry or a current collector using the binder.

As the binder used for a lithium ion secondary battery electrode, a styrene-butadiene rubber (SBR)-based water dispersion element in which carboxymethyl cellulose (CMC) is used as a thickener has been proposed (for example, refer to PTLs 2 to 4).

Since this SBR-based dispersion element is a water dispersion element, the dispersion is inexpensive and advantageous from the viewpoint of working environment conservation. This SBR-based dispersion element has favorable binding properties between active materials and between an active material and a current collector compared to the PVDF-based binder. Therefore, when the SBR-based dispersion element is used as a binder to form an electrode, compared to a case of using the PVDF-based binder, the content of the binder in the slurry can be reduced. Accordingly, by forming an electrode using the SBR-based dispersion element, compared to a case of using the PVDF-based binder, a lithium ion secondary battery having high output and high capacity can be obtained. From the above, the SBR-based dispersion element has been widely used as a binder for a lithium ion secondary battery electrode.

However, even when the SBR-based dispersion element is used, binding properties between active materials and between an active material and a current collector are not sufficient. Thus, when the content of the binder in slurry is small, in a cutting process that is carried out after applying the slurry onto the surface of the current collector and drying the slurry, there has been a problem of a part of the active material being peeled off from the surface of the current collector.

When the SBR-based dispersion element is used as a binder to form an electrode, there is a tendency to increase the resistance of the lithium ion secondary battery with charge and discharge of the lithium ion secondary battery.

Therefore, when the SBR-based dispersion element is used as the binder, a lithium ion secondary battery having a long service life cannot be obtained.

As the binder used for a lithium ion secondary battery electrode, in PTL 5, a binder obtained by emulsion polymerization of an ethylenically unsaturated monomer containing styrene, an ethylenically unsaturated carboxylic acid ester, an ethylenically unsaturated carboxylic acid, and an internal crosslinking agent in the presence of a surfactant has been proposed. However, even when this binder is used, there has been room for improvement in binding properties between active materials.

### CITATION LIST

### Patent Literature

[PTL 1] Japanese Unexamined Patent Application, First Publication No. H10-298386

[PTL 2] Japanese Unexamined Patent Application, First Publication No. H5-74461

[PTL 3] Japanese Unexamined Patent Application, First Publication No. H8-250123

[PTL 4] Japanese Unexamined Patent Application, First Publication No. 2011-204573

[PTL 5] Japanese Unexamined Patent Application, First Publication No. 2011-243464

### SUMMARY OF INVENTION

### Technical Problem

An object of the present invention is to solve the problems in the related art and provide a binder for a lithium ion secondary battery electrode. The binder for a lithium ion secondary battery electrode is a water-dispersible binder and has favorable binding properties between active materials and between an active material and a current collector. Therefore, it is possible to obtain a lithium ion secondary battery in which an active material is not easily peeled off from the surface of a current collector in a cutting process that is carried out after applying the slurry onto the surface of the current collector and drying the slurry even when the content of the binder in slurry is small and the service life characteristics are excellent during charge and discharge cycles. Another object of the present invention is to provide a slurry using the binder for a lithium ion secondary battery electrode of the present invention, an electrode using the slurry, and a lithium ion secondary battery using the electrode.

### Solution to Problem

The present invention relates to the following [1] to [7].

[1] A binder for a lithium ion secondary battery electrode that is obtained by emulsion polymerization of an ethylenically unsaturated monomer in an aqueous medium in the presence of a surfactant, the ethylenically unsaturated monomer being composed, with respect to the total mass of the ethylenically unsaturated monomer, of 15% by mass to 70% by mass of styrene, 1% by mass to 10% by mass of an N atom-containing ethylenically unsaturated monomer, 1% by mass to 10% by mass of an ethylenically unsaturated carboxylic acid, 0.1% by mass to 5% by mass of an internal crosslinking agent, and 22% by mass to 82.9% by mass of another ethylenically unsaturated monomer that is copolymerizable with these substances, and has a glass transition temperature of −55° C. to 30° C.

[2] The binder for a lithium ion secondary battery electrode according to [1], in which the N atom-containing ethylenically unsaturated monomer is at least one unsaturated monomer selected from (meth)acrylamide, N-alkyl(meth)acrylamide having 1 to 4 carbon atoms in the alkyl group, N,N-dialkyl(meth)acrylamide having 1 or 2 carbon atoms in the alkyl group, N-hydroxyalkyl(meth)acrylamide having 1 or 2 carbon atoms in the alkyl group, diacetone(meth)acrylamide, and dimethylaminoalkyl(meth)acrylamide having 1 to 4 carbon atoms in the alkyl group in a moiety excluding the dimethylamino group, and (meth)acrylamide-2-methyl propane sulfonic acid or (meth)acrylamide ethyl ethylene urea.

[3] The binder for a lithium ion secondary battery electrode according to [1] or [2], in which the ethylenically unsaturated carboxylic acid is at least one of unsaturated monocarboxylic acids selected from the group consisting of acrylic acid, methacrylic acid and crotonic acid, and unsaturated dicarboxylic acids selected from the group consisting of maleic acid, fumaric acid, and itaconic acid, and half esters of the unsaturated dicarboxylic acids.

[4] A slurry for a lithium ion secondary battery electrode including the binder for a lithium ion secondary battery electrode according to [1] or [2], an active material, and an aqueous medium.

[5] The slurry for a lithium ion secondary battery electrode according to [4], further including carboxymethyl cellulose.

[6] An electrode for a lithium ion secondary battery that is formed by using the slurry for a lithium ion secondary battery electrode according to [4] or [5].

[7] A lithium ion secondary battery including the electrode for a lithium ion secondary battery according to [6].

### Advantageous Effects of Invention

The binder for a lithium ion secondary battery electrode of the present invention is a water-dispersible binder and has favorable binding properties between active materials and between an active material and a current collector. Therefore, it is possible to provide a binder for a lithium ion secondary battery electrode capable of obtaining a lithium ion secondary battery in which an active material is not easily peeled off from the surface of a current collector in a cutting process that is carried out after applying the slurry onto the surface of the current collector and drying the slurry even when the content of the binder in the slurry is small and the service life characteristics are excellent during charge and discharge cycles.

### DESCRIPTION OF EMBODIMENTS

### [Binder for Lithium Ion Secondary Battery Electrode]

A binder for a lithium ion secondary battery electrode according to an embodiment (hereinafter, simply referred to as a “binder” in some cases) is obtained by emulsion polymerization of an ethylenically unsaturated monomer in the presence of a surfactant, and has a glass transition temperature of −55° C. to 30° C. The ethylenically unsaturated monomer is composed of specific amounts of styrene, an N atom-containing ethylenically unsaturated monomer, an ethylenically unsaturated carboxylic acid, an internal crosslinking agent, and another ethylenically unsaturated monomer that is copolymerizable with these substances.

### (Ethylenically Unsaturated Monomer)

The ethylenically unsaturated monomer which becomes the binder of the embodiment includes styrene as an essential constituent. The reason why the styrene is regarded as an essential constituent is for developing the binding properties of the binder between active materials and between an active material and a current collector. In particular, when a carbon material such as graphite is used as an active material of a lithium ion secondary battery electrode which is formed by using the binder of the embodiment, the effect of developing binding properties is remarkable.

The content of styrene included in the ethylenically unsaturated monomer is 15% by mass to 70% by mass, preferably 25% by mass to 65% by mass, and more preferably 35% by mass to 60% by mass with respect to the total mass of the ethylenically unsaturated monomer. When the content of styrene is 15% by mass or more, binding properties between active materials and between an active material and a current collector are excellent and adhesion between the active material and the current collector is improved. On the other hand, when the content of styrene is 70% by mass or less, the glass transition temperature (Tg) of the binder is excessively increased and thus an electrode formed by applying a slurry including the binder and an active material is not easily cracked.

Examples of the N atom-containing ethylenically unsaturated monomer included in the ethylenically unsaturated monomer include (meth)acrylamide which may be substituted, 2-(meth)acryloyloxyethyl isocyanate and a block body thereof, N-vinylacetamide, N-vinyl-2-pyrrolidone, and (meth)acrylonitrile. Among these, (meth)acrylamide which may be substituted is preferable.

Examples of the (meth)acrylamide which may be substituted include at least one unsaturated monomer selected from N-alkyl(meth)acrylamide having 1 to 5 carbon atoms in the alkyl group, N,N-dialkyl(meth)acrylamide having 1 to 3 carbon atoms in the alkyl group, N-hydroxyalkyl(meth)acrylamide having 1 to 3 carbon atoms in the alkyl group, diacetone(meth)acrylamide, and dimethylaminoalkyl(meth)acrylamide having 1 to 5 carbon atoms in the alkyl group in a moiety excluding the dimethylamino group, and (meth)acrylamide-2-methyl propane sulfonic acid or (meth)acrylamide ethyl ethylene urea.

2-Acryloyloxyethyl isocyanate and 2-methacryloyloxyethyl isocyanate are respectively available as Karenz AOI (registered trademark) and Karenz MOI (registered trademark) from SHOWA DENKO K.K. A block body of 2-(meth)acryloyloxyethyl isocyanate is obtained by blocking the isocyanate group of 2-(meth)acryloyloxyethyl isocyanate with a blocking agent such as methyl ethyl ketoxime or dimethylpyrazole. In addition, a block body of 2-methacryloyloxyethyl isocyanate is available as Karenz MOI-BM (registered trademark) and Karenz MOI-BP (registered trademark) from SHOWA DENKO K.K.

Among the N atom-containing ethylenically unsaturated monomers, at least one unsaturated monomer selected from (meth) acrylamide, N-isopropylacrylamide, N,N-dimethylacrylamide, dimethylamino propylacrylamide, diacetone acrylamide, acrylamide-2-methyl propane sulfonic acid, and (meth) acrylamide ethyl ethylene urea is preferably used. These monomers are excellent in binding properties between conductive assistants, between a conductive assistant and an active material, or among a conductive assistant, an active material, and an aluminum foil used as a current collector of an electrode.

When the number of carbon atoms in the alkyl group of N-alkyl(meth)acrylamide used as the N atom-containing ethylenically unsaturated monomer is 5 or less, there is a tendency for the polymerization reactivity of the ethylenically unsaturated monomer being sufficient.

When the number of carbon atoms in the alkyl group of N,N-dialkyl(meth)acrylamide used as the N atom-containing ethylenically unsaturated monomer is 3 or less, the number of carbon atoms in the alkyl group of N-hydroxyalkyl(meth)acrylamide is 3 or less, and the number of carbon atoms in the alkyl group of dimethylaminoalkyl(meth)acrylamide is 5 or less, there is a tendency for the polymerization reactivity of the ethylenically unsaturated monomer being sufficient.

The reason why the ethylenically unsaturated monomer, which becomes the binder of the embodiment, includes the N atom-containing ethylenically unsaturated monomer as an essential constituent is for developing the binding properties of the binder between the active materials and between the active material and the current collector and for decreasing the resistance of a lithium ion battery manufactured by using the binder of the embodiment.

The content of the N atom-containing ethylenically unsaturated monomer included in the ethylenically unsaturated monomer is 1% by mass to 10% by mass, preferably 1% by mass to 8% by mass, and more preferably 1% by mass to 6% by mass with respect to the total mass of the ethylenically unsaturated monomer. When the content of the N atom-containing ethylenically unsaturated monomer is within the above range, the binding properties of the binder between the active materials and between the active material and the current collector are improved.

Examples of the ethylenically unsaturated carboxylic acid included in the ethylenically unsaturated monomer include unsaturated monocarboxylic acids such as acrylic acid, methacrylic acid, and crotonic acid, and unsaturated dicarboxylic acids such as maleic acid, fumaric acid, and itaconic acid, and half esters of the unsaturated dicarboxylic acids. Among these, acrylic acid and itaconic acid, which are the most effective in improving the binding properties of the binder between the active materials and between the active material and current collector, are preferable. These ethylenically unsaturated carboxylic acids may be contained alone or contained in combination of two or more thereof in the ethylenically unsaturated monomer.

The reason why the binder of the embodiment includes the ethylenically unsaturated carboxylic acid as an essential constituent is for developing the binding properties of the binder between active materials and between an active material and a current collector and for improving emulsion polymerization stability.

The content of the ethylenically unsaturated carboxylic acid included in the ethylenically unsaturated monomer is 1% by mass to 10% by mass, preferably 2% by mass to 8% by mass, and more preferably 3% by mass to 6% by mass with respect to the total mass of the ethylenically unsaturated monomer. When the content of the ethylenically unsaturated carboxylic acid is 1% by mass or more, the emulsion polymerization stability or mechanical stability is improved. In addition, there is a tendency to improve binding properties between active materials and between an active material and a current collector. When the content of the ethylenically unsaturated carboxylic acid is 10% by mass or less, there is a tendency to improve binding properties between active materials and between an active material and a current collector.

Examples of the internal crosslinking agent included in the ethylenically unsaturated monomer include agents which have at least one ethylenically unsaturated bond and have a reactive group having reactivity with other functional groups or agents which have two or more ethylenically unsaturated bonds.

Specific examples of the agents which have at least one ethylenically unsaturated bond and have a reactive group having reactivity with other functional groups include silane coupling agents having at least one ethylenically unsaturated bond such as vinyl trimethoxy silane, vinyl triethoxy silane, γ-methacryloxypropyl trimethoxy silane, and γ-methacryloxypropyl triethoxy silane. Examples of the agents which have two or more ethylenically unsaturated bonds include divinylbenzene, ethylene glycol di(meth)acrylate, trimethylol propane tri(meth)acrylate, and triallyl cyanurate.

Among these internal crosslinking agents, divinylbenzene, trimethylol propane tri(meth)acrylate, vinyl trimethoxy silane, or vinyl triethoxy silane is preferably used and divinylbenzene is more preferably used. These internal crosslinking agents may be contained alone or may be contained in combination of two or more thereof in the ethylenically unsaturated monomer.

The content of the internal crosslinking agent included in the ethylenically unsaturated monomer is 0.1% by mass to 5% by mass, preferably 0.1% by mass to 3% by mass, and more preferably 0.2% by mass to 2% by mass with respect to the total mass of the ethylenically unsaturated monomer. When the content of the internal crosslinking agent is 0.1% by mass or more, the elution resistance of the binder to the electrolytic solution is favorable and the resistance of a lithium ion secondary battery is low, and thus a lithium ion secondary battery having high output and long service life can be obtained. Thus, the above content is preferable. When the content of the internal crosslinking agent is 5% by mass or less, there is a tendency to improve bonding properties between active materials and between an active material and a current collector.

Examples of another ethylenically unsaturated monomer that is copolymerizable with the styrene, the N atom-containing ethylenically unsaturated monomer, the ethylenically unsaturated carboxylic acid, and the internal crosslinking agent included in the ethylenically unsaturated monomer include ethylenically unsaturated carboxylic acid esters.

Examples of the ethylenically unsaturated carboxylic acid esters include (meth)acrylic acid esters such as methyl(meth)acrylate, ethyl(meth)acrylate, n-propyl(meth)acrylate, isopropyl(meth)acrylate, n-butyl(meth)acrylate, iso-butyl(meth)acrylate, tert-butyl meth)acrylate, n-hexyl(meth)acrylate, 2-ethylhexyl(meth)acrylate, lauryl(meth)acrylate, stearyl(meth)acrylate, cyclohexyl(meth)acrylate, isononyl(meth)acrylate, isobornyl(meth)acrylate, and benzyl(meth)acrylate, vinyl acetate, and vinyl propionate. Among these ethylenically unsaturated carboxylic acid esters, n-butyl(meth)acrylate, 2-ethylhexyl(meth)acrylate, and lauryl(meth)acrylate are preferably used from the viewpoint of ease of emulsion polymerization and elution resistance.

In addition, in the embodiment, within a range in which no damage is caused to the characteristics of the binder, the another ethylenically unsaturated monomer may contain compounds which have at least one polymerizable ethylenically unsaturated group and have a polar group such as a hydroxyl group and a glycidyl group. Examples of such compounds include 2-hydroxyethyl(meth)acrylate and glycidyl(meth)acrylate.

The content of the another ethylenically unsaturated monomer included in the ethylenically unsaturated monomer is 22% by mass to 82.9% by mass, preferably 30% by mass to 70% by mass, and more preferably 35% by mass to 60% by mass with respect to the total mass of the ethylenically unsaturated monomer. When the content of the another ethylenically unsaturated monomer is 22% by mass or more, an electrode obtained by applying the slurry including the binder and the active material has sufficient flexibility. When the content of the another ethylenically unsaturated monomer is 82.9% by mass or less, sufficiently high binding properties between active materials and between an active material and a current collector are obtained.

The ethylenically unsaturated monomer to be emulsion-polymerized in the embodiment may contain a molecular weight-adjusting agent such as mercaptan, thioglycolic acid and esters thereof, and β-mercaptopropionic acid and esters thereof in order to adjust the molecular weight of the binder obtained by emulsion polymerization.

### (Emulsion Polymerization)

The binder of the embodiment is obtained by emulsion polymerization of the ethylenically unsaturated monomer in an aqueous medium in the presence of a surfactant. During the emulsion polymerization in the embodiment, in the aqueous medium, a radical polymerization initiator is used.

As an emulsion polymerization method used for manufacturing the binder in the embodiment, for example, an emulsion polymerization method by collective introduction of all constituents used in emulsion polymerization, an emulsion polymerization method with continuous supply of each constituent used in emulsion polymerization, and the like are applied. Among these, since binder particles having a uniform and fine particle size are obtained and heat is effectively removed during reaction, a polymerization method of carrying out emulsion polymerization while continuously supplying each constituent used in emulsion polymerization is preferable. The emulsion polymerization is typically carried out while stirring at a temperature of 30° C. to 90° C.

As a surfactant used in the emulsion polymerization in the embodiment, an anionic surfactant or a non-ionic surfactant is used.

Examples of the anionic surfactant include alkylbenzene sulfonates, alkyl sulfate ester salts, polyoxyethylene alkyl ether sulfate ester salts, and fatty acid salts.

Examples of the non-ionic surfactant include polyoxyethylene alkyl ethers, polyoxyethylene alkyl phenyl ethers, polyoxyethylene polycyclic phinyl ethers, polyoxyalkylene alkyl ethers, sorbitan fatty acid esters, and polyoxyethylene sorbitan fatty acid esters.

These surfactants may be used alone or may be used in combination of two or more thereof.

In addition, the surfactant is not particularly limited. When surfactants represented by the following formulae (1) to (4) are used as more preferable surfactants, particle stability is improved and thus the use of surfactants is preferable.

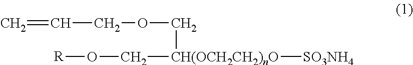

(In the formula (1), R is an alkyl group, and n is an integer of 10 to 40.)

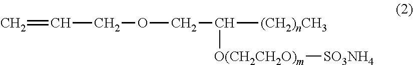

(In the formula (2), n is an integer of 10 to 12, and m is an integer of 10 to 40.)

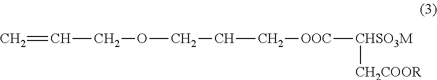

(In the formula (3), R is an alkyl group, and M is NH₄ or Na.)

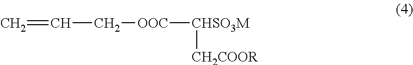

(In the formula (4), R is an alkyl group, and M is Na.)

The amount of the surfactant used is preferably 0.3 parts by mass to 3 parts by mass with respect to the total 100 parts by mass of the ethylenically unsaturated monomer. When the amount of the surfactant used is 0.3 parts by mass or more, the emulsion polymerization is easy and the mechanical stability of the obtained binder is increased. When the amount of the surfactant used is 0.3 parts by mass or more, the particle size of the aqueous emulsion which is a binder obtained by the emulsion polymerization is decreased and the sedimentation of the particles does not easily occur. Therefore, the amount of 0.3 parts by mass or more is preferable. When the amount of the surfactant used is 3 parts by mass or less, there is a tendency to improve the adhesion between an active material and a current collector. Even when surfactants represented by the above formulae (1) to (4) have ethylenically unsaturated bonds, the surfactants are not included in the “ethylenically unsaturated monomer” of the present invention.

A radical polymerization initiator used in the emulsion polymerization is not particularly limited and any known radical polymerization initiator can be used. Examples of the radical polymerization initiator include ammonium persulfate, potassium persulfate, hydrogen peroxide, and t-butyl hydroperoxide.

In the embodiment, as necessary, these radical polymerization initiators used in the emulsion polymerization may be used together with a reducing agent such as sodium bisulfate, Rongalite, and ascorbic acid, for redox polymerization.

In the embodiment, water can be used as an aqueous medium. In the embodiment, as long as the polymerization stability of the obtained binder is not deteriorated, a medium obtained by adding a hydrophilic solvent to water as the aqueous medium may be used. As the hydrophilic solvent to be added to water, methanol, ethanol, isopropyl alcohol, and N-methylpyrrolidone can be used.

In the embodiment, a basic substance may be added during the emulsion polymerization and/or after the completion of the emulsion polymerization for manufacturing the binder. Accordingly, the ethylenically unsaturated carboxylic acid included in the ethylenically unsaturated monomer is neutralized to adjust the pH and thus the polymerization stability, mechanical stability, and chemical stability in the ethylenically unsaturated monomer during the emulsion polymerization and/or in the binder after the completion of the emulsion polymerization can be improved.

As the basic substances used in this case, ammonia, triethylamine, sodium hydroxide, and lithium hydroxide can be used. These basic substances may be used alone, or may be used in combination of two or more thereof.

### (Glass Transition Temperature)

The binder of the embodiment has a glass transition temperature (Tg) of −55° C. to 30° C., preferably −25° C. to 25° C., and more preferably −20° C. to 10° C. When the Tg of the binder is within the above range, the binding properties of the binder between the active materials and between the active material and the current collector can be developed and the electrode obtained by using the slurry including the binder and the active material can be prevented from being cracked. When the Tg of the binder is lower than −55° C., there is a tendency to lower the binding properties between the active materials and between the active material and current collector. When the Tg of the binder is higher than 30° C., the electrode obtained by applying the slurry including the binder and the active material is cracked. The Tg of the binder can be adjusted by changing the content of styrene included in the ethylenically unsaturated monomer and the amount or type of ethylenically unsaturated monomer.

The glass transition temperature of the binder of the present invention is a theoretical value which is approximately calculated by the following Expression (I) from each glass transition temperature Tgi (i=1, 2, . . . , i) of each homopolymer of the ethylenically unsaturated monomer Mi (i=1, 2, . . . , i) used in the emulsion polymerization of the binder and each weight fraction Xi (i=1, 2, . . . , i) of the ethylenically unsaturated monomer Mi in a favorable manner.

1/Tg=Σ(Xi/Tgi) (I)

### (Binder Dispersion)

In the embodiment, since the binder for a lithium ion secondary battery electrode is obtained by emulsion polymerization in an aqueous medium, a binder dispersion in which the binder is dispersed in the aqueous medium is obtained. The non-volatile content of the binder dispersion is preferably 20% by mass to 60% by mass and more preferably 30% by mass to 50% by mass.

The pH of the binder dispersion is preferably 1.5 to 10 and more preferably 6 to 9.

The viscosity of the binder dispersion is preferably 1 mPa·s to 5000 mPa·s. On a flat plate-like vessel such as a dish or a plate, approximately 1 g of a resin is weighed, and dried at 105° C. for 1 hour, and the residue is used to calculate the non-volatile content of the binder dispersion of the present invention.

### “Slurry for Lithium Ion Secondary Battery Electrode”

Next, a slurry for a lithium ion secondary battery electrode according to the embodiment will be described in detail.

The slurry for a lithium ion secondary battery electrode according to the embodiment (hereinafter, simply referred to as a “slurry” in some cases) includes the binder of the embodiment, an active material, and an aqueous medium, and is obtained by dispersing or dissolving the binder dispersion and the active material in the aqueous medium.

The amount of the binder added to the slurry is preferably 0.2 parts by mass to 3 parts by mass with respect to 100 parts by mass of the active material as the binder dispersion having a non-volatile content of 20% by mass to 80% by mass. When the amount of the binder dispersion used is 0.2 parts by mass or more, bonding properties between the active material formed by applying and drying the slurry and the current collector are excellent and there is a tendency to improve charge and discharge cycle characteristics at a high temperature. When the amount of the binder dispersion used is 3 parts by mass or less, there is a tendency to increase the initial capacity of the lithium ion secondary battery obtained by using the slurry of the embodiment.

The active material may be any material as long as the material is able to be doped and undoped with lithium or the like. In the case where the slurry for a lithium ion secondary battery electrode of the embodiment is for forming a negative electrode, for example, conductive polymers such as polyacetylene and polypyrrole, or cokes such as coke, petroleum coke, pitch coke, and coal coke, carbon black such as polymer coal, carbon fibers, and acetylene black, graphite such as artificial graphite and natural graphite, lithium titanate, and silicon may be used. Among these active materials, carbon black, graphite, natural graphite, lithium titanate, and silicon are preferably used from the viewpoint of high energy density per volume. Among these materials, when carbon materials, that is, cokes such as coke, petroleum coke, pitch coke, and coal coke, carbon black such as polymer coal, carbon fibers, and acetylene black, and graphite such as artificial graphite and natural graphite are used, a remarkable effect of improving binding properties by the binder of the present invention is exhibited.

In the case where the slurry for a lithium ion secondary battery electrode of the embodiment is for forming a positive electrode, the positive electrode-active material is not particularly limited as long as the material is a positive electrode-active material that can be used for a lithium ion secondary battery. For example, among lithium composite oxides including nickel such as lithium cobalt oxide (LiCoO₂), Ni—Co—Mn-based lithium composite oxides, Ni—Mn—Al-based lithium composite oxides, and Ni—Co—Al-based lithium composite oxides, and chalcogen compounds such as spinel type lithium manganate (LiMn₂O₄), olivine type phosphoric acid iron lithium, TiS₂, MnO₂, MoO₃, and V₂O₅, the materials may be used alone or may be used in combination of two or more thereof.

The non-volatile content of the slurry of the embodiment is preferably 30% by mass to 70% by mass and more preferably 40% by mass to 60% by mass. The viscosity of the slurry is preferably 500 mPa·s to 20000 mPa·s and more preferably 5000 mPa·s to 20000 mPa·s. When the non-volatile content and the viscosity of the slurry are within the above-ranges, applicability to a current collector plate is favorable and the productivity of the electrode is excellent.

The non-volatile content of the slurry is adjusted by the amount of the aqueous medium (dispersion medium). The viscosity of the slurry is adjusted by the amount of the dispersion medium and a thickening material.

Typically, as the dispersion medium, water or a hydrophilic solvent is further added in addition to a solvent derived from the binder dispersion. Examples of the hydrophilic solvent include methanol, ethanol, isopropyl alcohol, and N-methylpyrrolidone.

Examples of the thickening material include celluloses such as carboxymethyl cellulose, hydroxyethyl cellulose, and hydroxypropyl cellulose, or ammonium and alkali metal salts thereof, poly(meth)acrylates or ammonium salts and alkali metal salts thereof, polyvinyl acetamide (NVA) or NVA-sodium acrylate copolymers, polyvinyl alcohols, and polyvinylpyrrolidone. Among these thickening materials, since the slurry in which the active material is dispersed can be easily prepared, carboxymethyl cellulose and poly(meth)acrylates or ammonium salts and alkali metal salts thereof, and polyvinyl acetamide (NVA) or NVA-sodium acrylate copolymers are preferably used.

The amount of the thickening material added to the slurry is preferably 0.5 parts by mass to 1.5 parts by mass with respect to 100 parts by mass of the active material. When the thickening material is included in the slurry with the above amount, the applicability of the slurry is favorable and binding properties between the active materials and between the active material and the current collector on an active material layer formed by applying and drying the slurry are further excellent.

A method of preparing the slurry of the embodiment is not particularly limited and known methods can be used. For example, a method of mixing a binder dispersion, an active material, a thickening material as necessary, and an aqueous medium (dispersion medium) using a mixing apparatus of a stirring type, a rotation type, or a vibration type may be used.

From the viewpoint of the durability of the battery, the pH of the slurry is preferably 2 to 10 and more preferably 6 to 9.

### “Electrode for Lithium Ion Secondary Battery”

The electrode according to this embodiment (electrode for a lithium ion secondary battery) is formed by using the slurry of the embodiment.

For example, the electrode of the embodiment can be manufactured by applying the slurry of the embodiment onto a current collector, drying the slurry to form an active material layer, and then cutting the current collector with the active material layer into an appropriate size.

The current collector used for the electrode of the embodiment is not particularly limited and examples thereof include metallic materials such as iron, copper, aluminum, nickel, and stainless steel. The shape of the current collector is not particularly limited and typically a sheet-like current collector having a thickness of 0.001 mm to 0.5 mm may be used.

A method of applying the slurry onto the current collector is not particularly limited and common application methods can be used. Examples thereof include a reverse roll method, a direct roll method, a doctor blade method, a knife method, an extrusion method, a curtain method, a gravure method, a bar method, a dip method, a squeeze method. Among these methods, a doctor blade method, a knife method, and an extrusion method are preferably used. These application methods are suitable in terms of various physical properties such as viscosity and drying properties of the slurry for a lithium ion secondary battery electrode and the applied layer with a favorable surface state can be obtained.

The application of the slurry onto the current collector may be carried out onto one side or both sides of the current collector. In the case of applying the slurry onto both sides of the current collector, the application may be sequentially carried out by one side, or simultaneously carried out onto both sides. In addition, the slurry may be applied continuously or intermittently onto the surface of the current collector. The thickness, length, and width of the applied layer formed by applying the slurry can be determined appropriately depending on the size of the battery.

A method of forming an active material layer by drying the applied layer that is formed by applying the slurry is not particularly limited and known methods can be used. For examples, as a drying method, hot air, vacuum, (far-)infrared rays, electron beams, and cool air can be used alone or in combination of two or more thereof.

The drying temperature for the applied layer is typically within the range of 40° C. to 180° C., and the drying time is typically 1 minute to 30 minutes.

In the embodiment, the current collector in which the active material layer is formed is cut so as to have an appropriate size and shape as an electrode. A method of cutting the current collector in which the active material layer is formed is not particularly limited. For example, a slit, laser, a wire cutter, a cutter, and a Thomson blade can be used.

In the embodiment, slipping of the active material is reduced and further the thickness of the electrode is reduced and thus a compact lithium ion secondary battery can be achieved. Therefore, before or the after the current collector in which the active material layer is formed is cut, as necessary, the current collector may be pressed. As the pressing method, common method can be used and particularly, a mold press method or roll press method is preferably used. The pressing pressure is not particularly limited and is preferably 0.5 t/cm² to 5 t/cm² within a range so as not to affect doping and undoping of the active material with lithium ions by pressing.

### “Lithium Ion Secondary Battery”

The battery (lithium ion secondary battery) according to this embodiment includes the electrode of the embodiment. The battery of the embodiment includes a positive electrode, a negative electrode, an electrolytic solution, and a component provided as necessary such as a separator, which are housed in an exterior body. In the embodiment, the electrode of the embodiment can be used for either or both of the positive electrode and the negative electrode. The shape of the electrode is not particularly limited and a laminated body and a wound body can be used.

The electrolytic solution includes an electrolyte and a solvent for dissolving the electrolyte.

As the electrolyte, known lithium salts can be used, and the electrolyte may be appropriately selected depending on the type of the active material. Examples of the electrolyte include LiClO₄, LiBF₆, LiPF₆, LiCF₃SO₃, LiCF₃CO₂, LiAsF₆, LiSbF₆, LiB₁₀Cl₁₀, LiAlCl₄, LiCl, LiBr, LiB(C₂H₅)₄, CF₃SO₃Li, CH₃SO₃Li, LiCF₃SO₃, LiC₄F₉SO₃, Li(CF₃SO₂)₂N, and aliphatic lithium carboxylate.

The solvent for dissolving the electrolyte is not particularly limited and known solvent can be used. For example, ethylene carbonate (EC), propylene carbonate (PC), diethyl carbonate (DEC), methylethyl carbonate (MEC), and dimethyl carbonate (DMC) can be used. These solvents may be used alone or in combination of two or more thereof. As the solvent, cyclic carbonate and chain carbonate are preferably used in combination.

As the exterior body, a metallic exterior body and an aluminum laminate exterior body can be used appropriately.

The shape of the battery may be any shape such as a coin shape, a button shape, a sheet shape, a cylindrical shape, a square shape, and a flat shape.

The battery of the embodiment can be manufactured using a known manufacturing method.

### EXAMPLES

Hereinafter, the present invention will be described in further detail with reference to Examples and Comparative Examples but the present invention is not limited to these examples.

It should be noted that the terms “parts” and “%” in the Examples and Comparative Examples respectively represent parts by mass and % by mass, unless otherwise noted.

The calculation Tg of the binder and the non-volatile content of the binder dispersion in each Example are as described above. In addition, for the binders used in Examples and Comparative Examples and the electrodes in Examples and Comparative Examples obtained by using these binders, physical properties and performance evaluation tests were carried out by the following methods.

### (Viscosity)

A Brookfield rotational viscometer was used to measure the viscosity at a liquid temperature of 23° C. and a revolution speed of 60 rpm with rotor No. 1, No. 2 or No. 3.

### (Peeling Strength Test of Electrode)

A slurry was applied onto a copper foil of a current collector so that the amount of the slurry applied after drying was 7 mg/cm². The slurry was dried by heating at 60° C. for 10 minutes, and subsequently subjected to drying at 120° C. for 10 minutes to obtain an electrode. The obtained electrode was left at 23° C. and 50% RH (relative humidity) for 24 hours to provide a test piece.

For a peeling strength test, a surface of the test piece onto which the slurry was applied and a stainless steel plate were bonded to each other with a double-faced tape, and subjected to 180° peeling (peeling width: 25 mm, peeling speed: 100 mm/min) to measure the peeling strength.

(Active Material Peeling during Cutting)

When the obtained electrode was cut with a cutter, whether or not the active material on the cut surface was peeled off was visually observed.

### (Resistance)

In order to measure the resistance of the electrode, first, the electrode was discharged at a constant current (0.2 C) until the voltage reached the lower limit voltage (2.75 V) and the residual capacity of the electrode was set to 0%. Then, the electrode was subjected to constant current and constant voltage (CC-CV) charge (the electrode was charged at a constant current (CC) (1 C) until the voltage reaches upper limit voltage (4.2 V) and charged at a constant voltage (CV) (4.2V) until 1.5 hours had passed) and discharged at CC (0.1 C) for 2 hours. Thus, the residual capacity of the electrode was adjusted to 80%.

Thereafter, the electrode was charged with a constant current at each current of 0.2 C, 0.5 C, 1 C and 2 C every one second and a plot was made while setting the current value after one second as a horizontal axis and the voltage as a vertical axis. From the obtained plot, the linear line was drawn according to linear approximation and the inclination was set to the resistance. This measurement was performed under the condition of 25° C. When the resistance was 3.9Ω or less, it was determined that the electrode was favorable.

### (Charge and Discharge Cycle Characteristics)

For the charge and discharge cycle test of the battery, CC-CV charge (charge at CC (1 C) until the voltage reached upper limit voltage (4.2 V) and charge at CV (4.2 V) until 1.5 hours had passed) and CC discharge (discharge at CC (1 C) until the voltage reached the lower limit voltage (2.75 V)) were repeated, each of which was carried out under the condition of 25° C. For the charge and discharge cycle characteristics of the battery, the capacity retention rate, that is, the ratio of the discharge capacity in the 300th cycle to the discharge capacity in the first cycle was used as an index. When the capacity retention rate was 85% or more, it was determined that the charge and discharge cycle characteristics of the battery were favorable.

### Synthesis of Binder

### Example 1-1

Into a separable flask with a cooling tube, a thermometer, a stirrer, and a dropping funnel, 175 parts by mass of water and 3 parts by mass of a surfactant shown in Table 1 were added, and heated to 75° C.

Then, while stirring a monomer mixture obtained by mixing and emulsifying the raw materials shown in Table 1 in advance and a polymerization initiator at 80° C. for 3 hours, the mixture was added dropwise into the separable flask for emulsion polymerization.

As the polymerization initiator, 2 parts by mass of potassium persulfate dissolved in 50 parts by mass of water was used.

After the monomer mixture and the polymerization initiator were added dropwise, the mixture was aged at 80° C. for 2 hours while stirring. Then, the mixture was cooled and neutralized by adding 17 parts by mass of ammonia water into the separable flask to obtain a binder dispersion A including a binder A.

TABLE 1

| | | | Example 1-1 | Example 1-2 | Example 1-3 | Example 1-4 | Example 1-5 |
|---|---|---|---|---|---|---|---|
| Binder | | | Binder A | Binder B | Binder C | Binder D | Binder E |
| Binder dispersion | | | Binder | Binder | Binder | Binder | Binder |
| | | | dispersion A | dispersion B | dispersion C | dispersion D | dispersion E |
| Monomer | Styrene | [Parts | 260 | 260 | 133 | 260 | 126 |
| mixture | | by mass] | | | | | |
| | Ethylenically | Type | Acrylic acid | Acrylic acid | Acrylic acid | Acrylic acid | Acrylic acid |
| | unsaturated | | (80% by mass | (80% by mass | (80% by mass | (80% by mass | (80% by mass |
| | carboxylic | | aqueous | aqueous | aqueous | aqueous | aqueous |
| | acid 1 | | solution) | solution) | solution) | solution) | solution) |
| | | Content | 15 | 15 | 15 | 15 | 15 |
| | | [Parts | | | | | |
| | | by mass] | | | | | |
| | Ethylenically | Type | Itaconic acid | Itaconic acid | Itaconic acid | Itaconic acid | Itaconic acid |
| | unsaturated | Content | 12 | 12 | 12 | 12 | 12 |
| | carboxylic | [Parts | | | | | |
| | acid 2 | by mass] | | | | | |
| | Ethylenically | Type | — | — | — | — | — |
| | unsaturated | Content | — | — | — | — | — |
| | carboxylic | [Parts | | | | | |
| | acid 3 | by mass] | | | | | |
| | N atom- | Type | Acrylamide | Meth- | N- | N,N- | Diacetone- |
| | containing | | (50% by mass | acrylamide | isopropyl- | dimethyl- | acrylamide |
| | unsaturated | | aqueous | | acrylamide | acrylamide | |
| | monomer | | solution) | | | | |
| | | Content | 22 | 7 | 10 | 10 | 50 |
| | | [Parts | | | | | |
| | | by mass] | | | | | |
| | Internal | Type | Divinyl- | Divinyl- | Divinyl- | Divinyl- | Divinyl- |
| | crosslinking | | benzene | benzene | benzene | benzene | benzene |
| | agent | Content | 1.5 | 1.5 | 1.5 | 1.5 | 1.5 |
| | | [Parts | | | | | |
| | | by mass] | | | | | |
| | Another | Type | 2-Ethylhexyl | 2-Ethylhexyl | n-Butyl | 2-Ethylhexyl | Lauryl |
| | ethylenically | | acrylate | acrylate | acrylate | acrylate | acrylate |
| | unsaturated | Content | 220 | 220 | 349 | 220 | 356 |
| | monomer | [Parts | | | | | |
| | | by mass] | | | | | |
| | Water | [Parts | 525 | 530 | 537 | 534 | 597 |
| | | by mass] | | | | | |
| | Surfactant 1 | Type | ELEMINOL | ELEMINOL | ELEMINOL | ELEMINOL | ELEMINOL |
| | | | JS-20 | JS-20 | JS-20 | JS-20 | JS-20 |
| | | | (40% by mass | (40% by mass | (40% by mass | (40% by mass | (40% by mass |
| | | | aqueous | aqueous | aqueous | aqueous | aqueous |
| | | | solution) | solution) | solution) | solution) | solution) |
| | | Content | 10 | 10 | 10 | 10 | 10 |
| | | [Parts | | | | | |
| | | by mass] | | | | | |
| | Surfactant 2 | Type | HITENOL 08E | HITENOL 08E | HITENOL 08E | HITENOL 08E | HITENOL 08E |
| | | Content | 2 | 2 | 2 | 2 | 2 |
| | | [Parts | | | | | |
| | | by mass] | | | | | |

| Surfactant | Type | ELEMINOL | ELEMINOL | ELEMINOL | ELEMINOL | ELEMINOL |
|---|---|---|---|---|---|---|
| (incorporated) | | JS-20 | JS-20 | JS-20 | JS-20 | JS-20 |
| | | (40% by mass | (40% by mass | (40% by mass | (40% by mass | (40% by mass |
| | | aqueous | aqueous | aqueous | aqueous | aqueous |
| | | solution) | solution) | solution) | solution) | solution) |
| | Content | 3 | 3 | 3 | 3 | 3 |
| | [Parts | | | | | |
| | by mass] | | | | | |
| Neutralizing agent | [Parts | 17 | 17 | 17 | 17 | 17 |
| (ammonia water) | by mass] | | | | | |

### Example 1-2 to 1-15

Each of binder dispersions B to O including binders B to O was obtained in the same manner as in Example 1-1, except that raw materials used were changed as shown in Tables 1 to 3.

In Tables, the details of the raw materials indicated by product names are as shown below.

ELEMINOL JS-20: 40% by mass aqueous solution of compound which has the structure formula of the formula (4), manufactured by Sanyo Chemical Industries, Ltd.

HITENOL 08E: Polyoxyethylene alkyl ether sulfate ester salt, manufactured by Dai-ichi Kogyo Seiyaku Co., Ltd.

SIPOMER WAM-II: Methacrylamidoethyl ethylene urea:methacrylic acid:water=5:2:3 (w/w), manufactured by Rhodia Nicca, Ltd.

Aquaron KH-10: Compound which has the structure formula of the formula (2), manufactured by Dai-ichi Kogyo Seiyaku Co., Ltd.

TABLE 2

| | | | Example 1-6 | Example 1-7 | Example 1-8 | Example 1-9 | Example 1-10 |
|---|---|---|---|---|---|---|---|
| Binder | | | Binder F | Binder G | Binder H | Binder I | Binder J |
| Binder dispersion | | | Binder | Binder | Binder | Binder | Binder |
| | | | dispersion F | dispersion G | dispersion H | dispersion I | dispersion J |
| Monomer | Styrene | [Parts | 260 | 260 | 260 | 260 | 260 |
| mixture | | by mass] | | | | | |
| | Ethylenically | Type | Acrylic acid | Acrylic acid | Acrylic acid | Acrylic acid | Acrylic acid |
| | unsaturated | | (80% by mass | (80% by mass | (80% by mass | (80% by mass | (80% by mass |
| | carboxylic | | aqueous | aqueous | aqueous | aqueous | aqueous |
| | acid 1 | | solution) | solution) | solution) | solution) | solution) |
| | | Content | 15 | 15 | 15 | 15 | 8 |
| | | [Parts | | | | | |
| | | by mass] | | | | | |
| | Ethylenically | Type | Itaconic acid | Itaconic acid | Itaconic acid | Itaconic acid | |
| | unsaturated | Content | 12 | 12 | 12 | 12 | — |
| | carboxylic | [Parts | | | | | |
| | acid 2 | by mass] | | | | | |
| | Ethylenically | Type | — | — | 20 Parts by | — | — |
| | unsaturated | Content | — | — | mass of | — | — |
| | carboxylic | [Parts | | | SIPOMER | | |
| | acid 3 | by mass] | | | WAM-II | | |
| | N atom- | Type | Dimethylamino | Acrylamide-2- | | Acrylamide | Acrylamide |
| | containing | | propyl- | methyl propane | | (50% by mass | (50% by mass |
| | unsaturated | | acrylamide | sulfonic acid | | aqueous | aqueous |
| | monomer | | | | | solution) | solution) |
| | | Content | 10 | 10 | | 22 | 22 |
| | | [Parts | | | | | |
| | | by mass] | | | | | |
| | Internal | Type | Divinyl- | Divinyl- | Divinyl- | Divinyl- | Divinyl- |
| | crosslinking | | benzene | benzene | benzene | benzene | benzene |
| | agent | Content | 1.5 | 1.5 | 1.5 | 1.5 | 1.5 |
| | | [Parts | | | | | |
| | | by mass] | | | | | |
| | Another | Type | 2-Ethylhexyl | 2-Ethylhexyl | 2-Ethylhexyl | 2-Ethylhexyl | 2-Ethylhexyl |
| | ethylenically | | acrylate | acrylate | acrylate | acrylate | acrylate |
| | unsaturated | Content | 220 | 220 | 220 | 220 | 220 |
| | monomer | [Parts | | | | | |
| | | by mass] | | | | | |
| | Water | [Parts | 534 | 534 | 531 | 525 | 525 |
| | | by mass] | | | | | |
| | Surfactant 1 | Type | ELEMINOL | ELEMINOL | ELEMINOL | Aquaron | ELEMINOL |
| | | | JS-20 | JS-20 | JS-20 | KH-10 | JS-20 |
| | | | (40% by mass | (40% by mass | (40% by mass | | (40% by mass |
| | | | aqueous | aqueous | aqueous | | aqueous |
| | | | solution) | solution) | solution) | | solution) |
| | | Content | 10 | 10 | 10 | 4 | 10 |
| | | [Parts | | | | | |
| | | by mass] | | | | | |
| | Surfactant 2 | Type | HITENOL 08E | HITENOL 08E | HITENOL 08E | HITENOL 08E | HITENOL 08E |
| | | Content | 2 | 2 | 2 | 2 | 2 |
| | | [Parts | | | | | |
| | | by mass] | | | | | |

| | | | | | | |
|---|---|---|---|---|---|---|
| Surfactant | Type | ELEMINOL | ELEMINOL | ELEMINOL | Aquaron | ELEMINOL |
| (incorporated) | | JS-20 | JS-20 | JS-20 | KH-10 | JS-20 |
| | | (40% by mass | (40% by mass | (40% by mass | | (40% by mass |
| | | aqueous | aqueous | aqueous | | aqueous |
| | | solution) | solution) | solution) | | solution) |
| | Content | 3 | 3 | 3 | 1 | 3 |
| | [Parts | | | | | |
| | by mass] | | | | | |
| Neutralizing agent | [Parts | 17 | 17 | 23 | 17 | 4 |
| (ammonia water) | by mass] | | | | | |

TABLE 3

| | | | Example 1-11 | Example 1-12 | Example 1-13 | Example 1-14 | Example 1-15 |
|---|---|---|---|---|---|---|---|
| Binder | | | Binder K | Binder L | Binder M | Binder N | Binder O |
| Binder dispersion | | | Binder | Binder | Binder | Binder | Binder |
| | | | dispersion K | dispersion L | dispersion M | dispersion N | dispersion O |
| Monomer | Styrene | [Parts | 260 | 80 | 335 | 260 | 260 |
| mixture | | by mass] | | | | | |
| | Ethylenically | Type | Acrylic acid | Acrylic acid | Acrylic acid | Acrylic acid | Acrylic acid |
| | unsaturated | | (80% by mass | (80% by mass | (80% by mass | (80% by mass | (80% by mass |
| | carboxylic | | aqueous | aqueous | aqueous | aqueous | aqueous |
| | acid 1 | | solution) | solution) | solution) | solution) | solution) |
| | | Content | 23 | 15 | 15 | 15 | 15 |
| | | [Parts | | | | | |
| | | by mass] | | | | | |
| | Ethylenically | Type | Itaconic acid | Itaconic acid | Itaconic acid | Itaconic acid | Itaconic acid |
| | unsaturated | Content | 32 | 12 | 12 | 12 | 12 |
| | carboxylic | [Parts | | | | | |
| | acid 2 | by mass] | | | | | |
| | Ethylenically | Type | — | — | — | — | — |
| | unsaturated | Content | — | — | — | — | — |
| | carboxylic | [Parts | | | | | |
| | acid 3 | by mass] | | | | | |
| | N atom- | Type | Acrylamide | Acrylamide | Acrylamide | Acrylamide | Acrylamide |
| | containing | | (50% by mass | (50% by mass | (50% by mass | (50% by mass | (50% by mass |
| | unsaturated | | aqueous | aqueous | aqueous | aqueous | aqueous |
| | monomer | | solution) | solution) | solution) | solution) | solution) |
| | | Content | 22 | 22 | 22 | 22 | 22 |
| | | [Parts | | | | | |
| | | by mass] | | | | | |
| | Internal | Type | Divinyl- | Divinyl- | Divinyl- | Vinyl | Divinyl- |
| | crosslinking | | benzene | benzene | benzene | trimethoxy | benzene |
| | agent | | | | | silane | |
| | | Content | 1.5 | 1.5 | 1.5 | 1 | 24 |
| | | [Parts | | | | | |
| | | by mass] | | | | | |
| | Another | Type | 2-Ethylhexyl | 2-Ethylhexyl | 2-Ethylhexyl | 2-Ethylhexyl | 2-Ethylhexyl |
| | ethylenically | | acrylate | acrylate | acrylate | acrylate | acrylate |
| | unsaturated | Content | 220 | 400 | 145 | 220 | 220 |
| | monomer | [Parts | | | | | |
| | | by mass] | | | | | |
| | Water | [Parts | 546 | 525 | 525 | 525 | 559 |
| | | by mass] | | | | | |
| | Surfactant 1 | Type | ELEMINOL | ELEMINOL | ELEMINOL | ELEMINOL | ELEMINOL |
| | | | JS-20 | JS-20 | JS-20 | JS-20 | JS-20 |
| | | | (40% by mass | (40% by mass | (40% by mass | (40% by mass | (40% by mass |
| | | | aqueous | aqueous | aqueous | aqueous | aqueous |
| | | | solution) | solution) | solution) | solution) | solution) |
| | | Content | 10 | 10 | 10 | 10 | 10 |
| | | [Parts | | | | | |
| | | by mass] | | | | | |
| | Surfactant 2 | Type | HITENOL 08E | HITENOL 08E | HITENOL 08E | HITENOL 08E | HITENOL 08E |
| | | Content | 2 | 2 | 2 | 2 | 2 |
| | | [Parts | | | | | |
| | | by mass] | | | | | |

| | | | | | | |
|---|---|---|---|---|---|---|
| Surfactant | Type | ELEMINOL | ELEMINOL | ELEMINOL | ELEMINOL | ELEMINOL |
| (incorporated) | | JS-20 | JS-20 | JS-20 | JS-20 | JS-20 |
| | | (40% by mass | (40% by mass | (40% by mass | (40% by mass | (40% by mass |
| | | aqueous | aqueous | aqueous | aqueous | aqueous |
| | | solution) | solution) | solution) | solution) | solution) |
| | Content | 3 | 3 | 3 | 3 | 3 |
| | [Parts | | | | | |
| | by mass] | | | | | |
| Neutralizing agent | [Parts | 36 | 17 | 17 | 17 | 17 |
| (ammonia water) | by mass] | | | | | |

### Comparative Examples 1-1 to 1-11

Each of binder dispersions P to Z including binders P to Z was obtained in the same manner as in Example 1-1, except that raw materials used were changed as shown in Tables 4 and 5.

TABLE 4

| | | | Comparative | Comparative | Comparative | Comparative | Comparative |
|---|---|---|---|---|---|---|---|
| | | | Example 1-1 | Example 1-2 | Example 1-3 | Example 1-4 | Example 1-5 |
| Binder | | | Binder P | Binder Q | Binder R | Binder S | Binder T |
| Binder dispersion | | | Binder | Binder | Binder | Binder | Binder |
| | | | dispersion P | dispersion Q | dispersion R | dispersion S | dispersion T |
| Monomer | Styrene | [Parts | 260 | 260 | 50 | 390 | 260 |
| mixture | | by mass] | | | | | |
| | Ethylenically | Type | Acrylic acid | Acrylic acid | Acrylic acid | Acrylic acid | — |
| | unsaturated | | (80% by mass | (80% by mass | (80% by mass | (80% by mass | |
| | carboxylic | | aqueous | aqueous | aqueous | aqueous | |
| | acid 1 | | solution) | solution) | solution) | solution) | |
| | | Content | 15 | 15 | 15 | 15 | — |
| | | [Parts | | | | | |
| | | by mass] | | | | | |
| | Ethylenically | Type | Itaconic acid | Itaconic acid | Itaconic acid | Itaconic acid | |
| | unsaturated | Content | 12 | 12 | 12 | 12 | — |
| | carboxylic | [Parts | | | | | |
| | acid 2 | by mass] | | | | | |
| | N atom- | Type | — | Acrylamide | Acrylamide | Acrylamide | Acrylamide |
| | containing | | | (50% by mass | (50% by mass | (50% by mass | (50% by mass |
| | unsaturated | | | aqueous | aqueous | aqueous | aqueous |
| | monomer | | | solution) | solution) | solution) | solution) |
| | | Content | — | 180 | 22 | 22 | 22 |
| | | [Parts | | | | | |
| | | by mass] | | | | | |
| | Internal | Type | Divinyl- | Divinyl- | Divinyl- | Divinyl- | Divinyl- |
| | crosslinking | | benzene | benzene | benzene | benzene | benzene |
| | agent | Content | 1.5 | 1.5 | 1.5 | 1.5 | 1.5 |
| | | [Parts | | | | | |
| | | by mass] | | | | | |
| | Another | Type | 2-Ethylhexyl | 2-Ethylhexyl | 2-Ethylhexyl | 2-Ethylhexyl | 2-Ethylhexyl |
| | ethylenically | | acrylate | acrylate | acrylate | acrylate | acrylate |
| | unsaturated | Content | 220 | 220 | 430 | 90 | 220 |
| | monomer | [Parts | | | | | |
| | | by mass] | | | | | |
| | Water | [Parts | 519 | 564 | 525 | 525 | 504 |
| | | by mass] | | | | | |
| | Surfactant 1 | Type | ELEMINOL | ELEMINOL | ELEMINOL | ELEMINOL | ELEMINOL |
| | | | JS-20 | JS-20 | JS-20 | JS-20 | JS-20 |
| | | | (40% by mass | (40% by mass | (40% by mass | (40% by mass | (40% by mass |
| | | | aqueous | aqueous | aqueous | aqueous | aqueous |
| | | | solution) | solution) | solution) | solution) | solution) |
| | | Content | 10 | 10 | 10 | 10 | 10 |
| | | [Parts | | | | | |
| | | by mass] | | | | | |
| | Surfactant 2 | Type | HITENOL 08E | HITENOL 08E | HITENOL 08E | HITENOL 08E | HITENOL 08E |
| | | Content | 2 | 2 | 2 | 2 | 2 |
| | | [Parts | | | | | |
| | | by mass] | | | | | |

| | | | | | | |
|---|---|---|---|---|---|---|
| Surfactant | Type | ELEMINOL | ELEMINOL | ELEMINOL | ELEMINOL | ELEMINOL |
| (incorporated) | | JS-20 | JS-20 | JS-20 | JS-20 | JS-20 |
| | | (40% by mass | (40% by mass | (40% by mass | (40% by mass | (40% by mass |
| | | aqueous | aqueous | aqueous | aqueous | aqueous |
| | | solution) | solution) | solution) | solution) | solution) |
| | Content | 3 | 3 | 3 | 3 | 3 |
| | [Parts | | | | | |
| | by mass] | | | | | |
| Neutralizing agent | [Parts | 17 | 17 | 17 | 17 | 17 |
| (ammonia water) | by mass] | | | | | |

TABLE 5

| | | | Comparative | Comparative | Comparative | Comparative | Comparative | Comparative |
|---|---|---|---|---|---|---|---|---|
| | | | Example 1-6 | Example 1-7 | Example 1-8 | Example 1-9 | Example 1-10 | Example 1-11 |
| Binder | | | Binder U | Binder V | Binder W | Binder X | Binder Y | Binder Z |
| Binder dispersion | | | Binder | Binder | Binder | Binder | Binder | Binder |
| | | | dispersion U | dispersion V | dispersion W | dispersion X | dispersion Y | dispersion Z |
| Monomer | Styrene | [Parts | 260 | 360 | 260 | 260 | 65 | 300 |
| mixture | | by mass] | | | | | | |
| | Ethylenically | Type | Acrylic acid | Acrylic acid | Acrylic acid | Acrylic acid | Acrylic acid | Acrylic acid |
| | unsaturated | | (80% by mass | (80% by mass | (80% by mass | (80% by mass | (80% by mass | (80% by mass |
| | carboxylic | | aqueous | aqueous | aqueous | aqueous | aqueous | aqueous |
| | acid 1 | | solution) | solution) | solution) | solution) | solution) | solution) |
| | | Content | 41 | 15 | 15 | 15 | 15 | 17 |
| | | [Parts | | | | | | |
| | | by mass] | | | | | | |
| | Ethylenically | Type | Itaconic acid | Itaconic acid | Itaconic acid | Itaconic acid | Itaconic acid | Itaconic acid |
| | unsaturated | Content | 37 | 12 | 12 | 12 | 12 | 10 |
| | carboxylic | [Parts | | | | | | |
| | acid 2 | by mass] | | | | | | |
| | N atom- | Type | Acrylamide | Acrylamide | Acrylamide | Acrylamide | Acrylamide | Acrylamide |
| | containing | | (50% by mass | (50% by mass | (50% by mass | (50% by mass | (50% by mass | (50% by mass |
| | unsaturated | | aqueous | aqueous | aqueous | aqueous | aqueous | aqueous |
| | monomer | | solution) | solution) | solution) | solution) | solution) | solution) |
| | | Content | 22 | 22 | 22 | 22 | 22 | 100 |
| | | [Parts | | | | | | |
| | | by mass] | | | | | | |
| | Internal | Type | Divinyl- | Divinyl- | — | Divinyl- | Divinyl- | Divinyl- |
| | crosslinking | | benzene | benzene | | benzene | benzene | benzene |
| | agent | Content | 1.5 | 1.5 | — | 31 | 1.5 | 1.5 |
| | | [Parts | | | | | | |
| | | by mass] | | | | | | |
| | Another | Type | 2-Ethylhexyl | 2-Ethylhexyl | 2-Ethylhexyl | 2-Ethylhexyl | 2-Ethylhexyl | 2-Ethylhexyl |
| | ethylenically | | acrylate | acrylate | acrylate | acrylate | acrylate | acrylate |
| | unsaturated | Content | 220 | 120 | 220 | 220 | 415 | 125 |
| | monomer | [Parts | | | | | | |
| | | by mass] | | | | | | |
| | Water | [Parts | 561 | 525 | 525 | 569 | 525 | 508 |
| | | by mass] | | | | | | |
| | Surfactant 1 | Type | ELEMINOL | ELEMINOL | ELEMINOL | ELEMINOL | ELEMINOL | ELEMINOL |
| | | | JS-20 | JS-20 | JS-20 | JS-20 | JS-20 | JS-20 |
| | | | (40% by mass | (40% by mass | (40% by mass | (40% by mass | (40% by mass | (40% by mass |
| | | | aqueous | aqueous | aqueous | aqueous | aqueous | aqueous |
| | | | solution) | solution) | solution) | solution) | solution) | solution) |
| | | Content | 10 | 10 | 10 | 10 | 10 | 10 |
| | | [Parts | | | | | | |
| | | by mass] | | | | | | |
| | Surfactant 2 | Type | HITENOL 08E | HITENOL 08E | HITENOL 08E | HITENOL 08E | HITENOL 08E | HITENOL 08E |
| | | Content | 2 | 2 | 2 | 2 | 2 | 2 |
| | | [Parts | | | | | | |
| | | by mass] | | | | | | |

| Surfactant | Type | ELEMINOL | ELEMINOL | ELEMINOL | ELEMINOL | ELEMINOL | ELEMINOL |
|---|---|---|---|---|---|---|---|
| (incorporated) | | JS-20 | JS-20 | JS-20 | JS-20 | JS-20 | JS-20 |
| | | (40% by mass | (40% by mass | (40% by mass | (40% by mass | (40% by mass | (40% by mass |
| | | aqueous | aqueous | aqueous | aqueous | aqueous | aqueous |
| | | solution) | solution) | solution) | solution) | solution) | solution) |
| | Content | 3 | 3 | 3 | 3 | 3 | 3 |
| | [Parts | | | | | | |
| | by mass] | | | | | | |
| Neutralizing agent | [Parts | 17 | 17 | 17 | 17 | 17 | 17 |
| (ammonia water) | by mass] | | | | | | |

The raw material composition and glass transition temperature of each binder synthesized in Examples 1-1 to 1-15 and the non-volatile content, viscosity, and pH of each binder dispersion are shown in Tables 6 to 8. In the same manner, the raw material composition and glass transition temperature of each binder synthesized in Comparative Examples 1-1 to 1-11 and the non-volatile content, viscosity, and pH of each binder dispersion are shown in Tables 9 and 10.

In Tables, the composition ratio of the raw materials used as an aqueous solution for reaction was converted into a non-volatile content.

TABLE 6

| | | | Example1 1 | Example1 2 | Example1 3 | Example1 4 | Example1 5 |
|---|---|---|---|---|---|---|---|
| | | | Binder A | Binder B | Binder C | Binder D | Binder E |
| Ethylenically | Styrene | Composition | 50 | 51 | 26 | 50 | 23 |
| unsaturated | | ratio [% by | | | | | |
| monomer | | mass] | | | | | |
| | Ethylenically | Type | Acrylic acid | Acrylic acid | Acrylic acid | Acrylic acid | Acrylic acid |
| | unsaturated | Composition | 2.3 | 2.3 | 2.3 | 2.3 | 2.2 |
| | carboxylic | ratio [% by | | | | | |
| | acid 1 | mass] | | | | | |
| | Ethylenically | Type | Itaconic acid | Itaconic acid | Itaconic acid | Itaconic acid | Itaconic acid |
| | unsaturated | Composition | 2.3 | 2.3 | 2.3 | 2.3 | 2.2 |
| | carboxylic | ratio [% by | | | | | |
| | acid 2 | mass] | | | | | |
| | Ethylenically | Type | — | — | — | — | — |
| | unsaturated | Composition | — | — | — | — | — |
| | carboxylic | ratio [% by | | | | | |
| | acid 3 | mass] | | | | | |
| | N atom- | Type | Acrylamide | Meth- | N- | N,N- | Diacetone- |
| | containing | | | acrylamide | isopropyl- | dimethyl- | acrylamide |
| | ethylenically | | | | acrylamide | acrylamide | |
| | unsaturated | Composition | 2.1 | 2.1 | 1.4 | 1.9 | 9.0 |
| | monomer | ratio [% by | | | | | |
| | | mass] | | | | | |
| | Internal | Type | Divinyl- | Divinyl- | Divinyl- | Divinyl- | Divinyl- |
| | crosslinking | | benzene | benzene | benzene | benzene | benzene |
| | agent | Composition | 0.3 | 0.3 | 0.3 | 0.3 | 0.3 |
| | | ratio [% by | | | | | |
| | | mass] | | | | | |
| | Another | Type | 2-Ethylhexyl | 2-Ethylhexyl | n-Butyl- | 2-Ethylhexyl | Lauryl |
| | ethylenically | | acrylate | acrylate | acrylate | acrylate | acrylate |
| | unsaturated | Composition | 43 | 43 | 67 | 43 | 64 |
| | monomer | ratio [% by | | | | | |
| | | mass] | | | | | |

| | | | | | | |
|---|---|---|---|---|---|---|
| Surfactant | Composition | 1.4 | 1.4 | 1.4 | 1.4 | 1.3 |
| | ratio [parts | | | | | |
| | by mass/100 | | | | | |
| | parts by | | | | | |
| | mass of | | | | | |
| | ethylenically | | | | | |
| | unsaturated | | | | | |
| | monomer] | | | | | |

| Binde-glass transition temperature [° C.] | | 0 | 0 | −20 | 0 | 25 |
|---|---|---|---|---|---|---|
| | | Binder | Binder | Binder | Binder | Binder |
| | | dispersion A | dispersion B | dispersion C | dispersion D | dispersion E |
| | Non-volatile content | 40 | 40 | 40 | 40 | 40 |
| | [% by mass] | | | | | |
| | Viscosity [mPa · s] | 120 | 50 | 240 | 100 | 500 |
| | pH | 7.1 | 7.2 | 7.0 | 7.1 | 7.5 |

TABLE 7

| | | | Example 1-6 | Example 1-7 | Example 1-8 | Example 1-9 | Example 1-10 |
|---|---|---|---|---|---|---|---|
| Binder | | | Binder F | Binder G | Binder H | Binder I | Binder J |
| Ethylenically | Styrene | Composition | 50 | 50 | 50 | 50 | 52 |
| unsaturated | | ratio [% by | | | | | |
| monomer | | mass] | | | | | |
| | Ethylenically | Type | Acrylic acid | Acrylic acid | Acrylic acid | Acrylic acid | Acrylic acid |
| | unsaturated | Composition | 2.3 | 2.3 | 2.3 | 2.3 | 1.3 |
| | carboxylic | ratio [% by | | | | | |
| | acid 1 | mass] | | | | | |
| | Ethylenically | Type | Itaconic acid | Itaconic acid | Itaconic acid | Itaconic acid | — |
| | unsaturated | Composition | 2.3 | 2.3 | 2.3 | 2.3 | — |
| | carboxylic | ratio [% by | | | | | |
| | acid 2 | mass] | | | | | |
| | Ethylenically | Type | — | — | Methacrylic | — | — |
| | unsaturated | | | | acid | | |
| | carboxylic | Composition | — | — | 0.8 | — | — |
| | acid 3 | ratio [% by | | | | | |
| | | mass] | | | | | |
| | N atom- | Type | Dimethylamino | Acrylamide-2- | Methacryl- | Acrylamide | Acrylamide |
| | containing | | propyl- | methyl propane | amide ethyl | | |
| | ethylenically | | acrylamide | sulfonic acid | ethylene urea | | |
| | unsaturated | Composition | 1.9 | 1.9 | 1.9 | 2.1 | 2.2 |
| | monomer | ratio [% by | | | | | |
| | | mass] | | | | | |
| | Internal | Type | Divinyl- | Divinyl- | Divinyl- | Divinyl- | Divinyl- |
| | crosslinking | | benzene | benzene | benzene | benzene | benzene |
| | agent | Composition | 0.3 | 0.3 | 0.3 | 0.3 | 0.3 |
| | | ratio [% by | | | | | |
| | | mass] | | | | | |
| | Another | Type | 2-Ethylhexyl | 2-Ethylhexyl | 2-Ethylhexyl | 2-Ethylhexyl | 2-Ethylhexyl |
| | ethylenically | | acrylate | acrylate | acrylate | acrylate | acrylate |
| | unsaturated | Composition | 43 | 43 | 42 | 43 | 44 |
| | monomer | ratio [% by | | | | | |
| | | mass] | | | | | |

| | | | | | | |
|---|---|---|---|---|---|---|
| Surfactant | Composition | 1.4 | 1.4 | 1.4 | 1.4 | 1.4 |
| | ratio [parts | | | | | |
| | by mass/100 | | | | | |
| | parts by | | | | | |
| | mass of | | | | | |
| | ethylenically | | | | | |
| | unsaturated | | | | | |
| | monomer] | | | | | |

| Binder-glass transition temperature [° C.] | | 0 | −15 | 0 | 0 | 0 |
|---|---|---|---|---|---|---|
| Binder dispersion | | Binder | Binder | Binder | Binder | Binder |
| | | dispersion F | dispersion G | dispersion H | dispersion I | dispersion J |
| | Non-volatile content | 40 | 40 | 40 | 40 | 40 |
| | [% by mass] | | | | | |
| | Viscosity [mPa · s] | 60 | 40 | 100 | 110 | 120 |
| | pH | 7.0 | 7.0 | 7.2 | 7.1 | 7.3 |

TABLE 8

| | | | Example 1-11 | Example 1-12 | Example 1-13 | Example 1-14 | Example 1-15 |
|---|---|---|---|---|---|---|---|
| Binder | | | Binder K | Binder L | Binder M | Binder N | Binder O |
| Ethylenically | Styrene | Composition | 48 | 16 | 65 | 50 | 48 |
| unsaturated | | ratio [% by | | | | | |
| monomer | | mass] | | | | | |
| | Ethylenically | Type | Acrylic acid | Acrylic acid | Acrylic acid | Acrylic acid | Acrylic acid |
| | unsaturated | Composition | 3.4 | 2.3 | 2.3 | 2.3 | 2.3 |
| | carboxylic | ratio [% by | | | | | |
| | acid 1 | mass] | | | | | |
| | Ethylenically | Type | Itaconic acid | Itaconic acid | Itaconic acid | Itaconic acid | Itaconic acid |
| | unsaturated | Composition | 5.9 | 2.3 | 2.3 | 2.3 | 2.3 |
| | carboxylic | ratio [% by | | | | | |
| | acid 2 | mass] | | | | | |
| | Ethylenically | Type | — | — | — | — | — |
| | unsaturated | Composition | — | — | — | — | — |
| | carboxylic | ratio [% by | | | | | |
| | acid 3 | mass] | | | | | |
| | N atom- | Type | Acrylamide | Acrylamide | Acrylamide | Acrylamide | Acrylamide |
| | containing | Composition | 2.0 | 2.1 | 2.1 | 2.1 | 2.1 |
| | ethylenically | ratio [% by | | | | | |
| | unsaturated | mass] | | | | | |
| | monomer | | | | | | |
| | Internal | Type | Divinyl- | Divinyl- | Divinyl- | Vinyl | Divinyl- |
| | crosslinking | | benzene | benzene | benzene | trimethoxy | benzene |
| | agent | | | | | silane | |
| | | Composition | 0.3 | 0.3 | 0.3 | 0.2 | 4.5 |
| | | ratio [% by | | | | | |
| | | mass] | | | | | |
| | Another | Type | 2-Ethylhexyl | 2-Ethylhexyl | 2-Ethylhexyl | 2-Ethylhexyl | 2-Ethylhexyl |
| | ethylenically | | acrylate | acrylate | acrylate | acrylate | acrylate |
| | unsaturated | Composition | 41 | 76 | 28 | 43 | 40 |
| | monomer | ratio [% by | | | | | |
| | | mass] | | | | | |

| | | | | | | |
|---|---|---|---|---|---|---|
| Surfactant | Composition | 1.3 | 1.4 | 1.4 | 1.4 | 1.4 |
| | ratio [parts | | | | | |
| | by mass/100 | | | | | |
| | parts by | | | | | |
| | mass of | | | | | |
| | ethylenically | | | | | |
| | unsaturated | | | | | |
| | monomer] | | | | | |

| Binder-glass transition temperature [° C.] | | 0 | −50 | 25 | 0 | 5 |
|---|---|---|---|---|---|---|
| Binder dispersion | | Binder | Binder | Binder | Binder | Binder |
| | | dispersion K | dispersion L | dispersion M | dispersion N | dispersion O |
| | Non-volatile content | 40 | 40 | 40 | 40 | 40 |
| | [% by mass] | | | | | |
| | Viscosity [mPa · s] | 110 | 220 | 130 | 110 | 140 |
| | pH | 7.0 | 7.4 | 7.3 | 7.2 | 7.3 |

TABLE 9

| | | | Comparative | Comparative | Comparative | Comparative | Comparative |
|---|---|---|---|---|---|---|---|
| | | | Example 1-1 | Example 1-2 | Example 1-3 | Example 1-4 | Example 1-5 |
| Binder | | | Binder P | Binder Q | Binder R | Binder S | Binder T |
| Ethylenically | Styrene | Composition | 51 | 44 | 10 | 76 | 53 |
| unsaturated | | ratio [% by | | | | | |
| monomer | | mass] | | | | | |
| | Ethylenically | Type | Acrylic acid | Acrylic acid | Acrylic acid | Acrylic acid | — |
| | unsaturated | Composition | 2.4 | 2.0 | 2.3 | 2.3 | — |
| | carboxylic | ratio [% by | | | | | |
| | acid 1 | mass] | | | | | |
| | Ethylenically | Type | Itaconic acid | Itaconic acid | Itaconic acid | Itaconic acid | — |
| | unsaturated | Composition | 2.4 | 2.0 | 2.3 | 2.3 | — |
| | carboxylic | ratio [% by | | | | | |
| | acid 2 | mass] | | | | | |
| | N atom- | Type | — | Acrylamide | Acrylamide | Acrylamide | Acrylamide |
| | containing | Composition | — | 15 | 2.1 | 2.1 | 2.2 |
| | ethylenically | ratio [% by | | | | | |
| | unsaturated | mass] | | | | | |
| | monomer | | | | | | |
| | Internal | Type | Divinyl- | Divinyl- | Divinyl- | Divinyl- | Divinyl- |
| | crosslinking | | benzene | benzene | benzene | benzene | benzene |
| | agent | Composition | 0.3 | 0.3 | 0.3 | 0.3 | 0.3 |
| | | ratio [% by | | | | | |
| | | mass] | | | | | |
| | Another | Type | 2-Ethylhexyl | 2-Ethylhexyl | 2-Ethylhexyl | 2-Ethylhexyl | 2-Ethylhexyl |
| | ethylenically | | acrylate | acrylate | acrylate | acrylate | acrylate |
| | unsaturated | Composition | 44 | 37 | 83 | 17 | 45 |
| | monomer | ratio [% by | | | | | |
| | | mass] | | | | | |

| | | | | | | |
|---|---|---|---|---|---|---|
| Surfactant | Composition | 1.4 | 1.2 | 1.4 | 1.4 | 1.5 |
| | ratio [parts | | | | | |
| | by mass/100 | | | | | |
| | parts by | | | | | |
| | mass of | | | | | |
| | ethylenically | | | | | |
| | unsaturated | | | | | |
| | monomer] | | | | | |

| Binder-glass transition temperature [° C.] | | 0 | 10 | −55 | 50 | 0 |
|---|---|---|---|---|---|---|
| Binder dispersion | | Binder | Binder | Binder | Binder | Binder |
| | | dispersion P | dispersion Q | dispersion R | dispersion S | dispersion T |
| | Non-volatile content | 40 | 40 | 40 | 40 | 40 |
| | [% by mass] | | | | | |
| | Viscosity [mPa · s] | 30 | 520 | 250 | 200 | 50 |
| | pH | 7.0 | 7.5 | 7.2 | 7.0 | 7.2 |

TABLE 10

| | | | Comparative | Comparative | Comparative | Comparative | Comparative | Comparative |
|---|---|---|---|---|---|---|---|---|
| | | | Example 1-6 | Example 1-7 | Example 1-8 | Example 1-9 | Example 1-10 | Example 1-11 |
| Binder | | | Binder U | Binder V | Binder W | Binder X | Binder Y | Binder Z |
| Ethylenically | Styrene | Composition | 46 | 70 | 51 | 48 | 12 | 60 |
| unsaturated | | ratio [% by | | | | | | |
| monomer | | mass] | | | | | | |
| | Ethylenically | Type | Acrylic acid | Acrylic acid | Acrylic acid | Acrylic acid | Acrylic acid | Acrylic acid |
| | unsaturated | Composition | 5.8 | 2.3 | 2.3 | 2.2 | 2.3 | 2.7 |
| | carboxylic | ratio [% by | | | | | | |
| | acid 1 | mass] | | | | | | |
| | Ethylenically | Type | Itaconic acid | Itaconic acid | Itaconic acid | Itaconic acid | Itaconic acid | Itaconic acid |
| | unsaturated | Composition | 6.6 | 2.3 | 2.3 | 2.2 | 2.3 | 2.0 |
| | carboxylic | ratio [% by | | | | | | |
| | acid 2 | mass] | | | | | | |
| | N atom- | Type | Acrylamide | Acrylamide | Acrylamide | Acrylamide | Acrylamide | Acrylamide |
| | containing | Composition | 2.0 | 2.1 | 2.1 | 2.0 | 2.1 | 10.0 |
| | ethylenically | ratio [% by | | | | | | |
| | unsaturated | mass] | | | | | | |
| | monomer | | | | | | | |
| | Internal | Type | Divinyl- | Divinyl- | — | Divinyl- | Divinyl- | Divinyl- |
| | crosslinking | | benzene | benzene | | benzene | benzene | benzene |
| | agent | Composition | 0.3 | 0.3 | — | 6.0 | 0.3 | 0.3 |
| | | ratio [% by | | | | | | |
| | | mass] | | | | | | |
| | Another | Type | 2-Ethylhexyl | 2-Ethylhexyl | 2-Ethylhexyl | 2-Ethylhexyl | 2-Ethylhexyl | 2-Ethylhexyl |
| | ethylenically | | acrylate | acrylate | acrylate | acrylate | acrylate | acrylate |
| | unsaturated | Composition | 39 | 23 | 43 | 40 | 81 | 25 |
| | monomer | ratio [% by | | | | | | |
| | | mass] | | | | | | |

| | | | | | | | |
|---|---|---|---|---|---|---|---|
| Surfactant | Composition | 1.3 | 1.4 | 1.4 | 1.3 | 1.4 | 1.4 |
| | ratio [parts | | | | | | |
| | by mass/100 | | | | | | |
| | parts by | | | | | | |
| | mass of | | | | | | |
| | ethylenically | | | | | | |
| | unsaturated | | | | | | |
| | monomer] | | | | | | |

| Binder-glass transition temperature [° C.] | | 5 | 35 | 0 | 5 | −50 | 33 |
|---|---|---|---|---|---|---|---|
| Binder dispersion | | Binder | Binder | Binder | Binder | Binder | Binder |
| | | dispersion U | dispersion V | dispersion W | dispersion X | dispersion Y | dispersion Z |
| | Non-volatile content | 40 | 40 | 40 | 40 | 40 | 40 |
| | [% by mass] | | | | | | |
| | Viscosity [mPa · s] | 500 | 120 | 100 | 150 | 260 | 180 |
| | pH | 7.4 | 7.3 | 7.2 | 7.1 | 7.1 | 7.3 |

### (Preparation of Lithium Ion Secondary Battery)

The slurries including the thus-obtained binders A to X were used to form electrodes as shown below and batteries including the electrodes in Examples 2-1 to 2-18 and Comparative Examples 2-1 to 2-11 were manufactured and evaluated. The results are shown in Table 11.

“N.D.” shown in Table 11 indicates that poor dispersion occurred during the mixing of the slurry and thus an electrode was not obtained.

TABLE 11

| | | | | | | | Negative electrode | | | Battery | | |
|---|---|---|---|---|---|---|---|---|---|---|---|---|
| | | Slurry | | | | | | | Active | | | Charge and |
| | | Amount of binder | | Non- | | | | | material | | | discharge |
| | | dispersion used | | volatile | | | | | layer | | | cycle |
| | | [parts by mass/100 | Thick- | content | | | Negative | Peeling | peeling | | Resis- | character- |
| | Binder | parts by mass of | ening | [% by | Vis- | | electrode | strength | during | Battery | tance | istics |
| | name | active material] | material | mass] | cosity | pH | name | [mN/mm] | cutting | name | [Ω] | [%] |
| Example 2-1 | A | 2 | CMC | 53.5 | 10000 | 7.8 | A1 | 18 | Not | A1 | 3.5 | 93 |
| | | | | | | | | | peeled | | | |
| Example 2-2 | A | 2 | PVa | 55.0 | 10000 | 8.1 | A2 | 16 | Not | A2 | 3.7 | 90 |
| | | | | | | | | | peeled | | | |
| Example 2-3 | A | 2 | NVA-Aa | 51.4 | 550 | 7.6 | A3 | 17 | Not | A3 | 3.7 | 92 |
| | | | | | | | | | peeled | | | |
| Example 2-4 | A | 5 | — | 60.2 | 10000 | 7.5 | A4 | 19 | Not | A4 | 3.5 | 91 |
| | | | | | | | | | peeled | | | |
| Example 2-5 | B | 2 | CMC | 54.2 | 10000 | 7.9 | B | 16 | Not | B | 3.8 | 93 |
| | | | | | | | | | peeled | | | |
| Example 2-6 | C | 2 | CMC | 53.1 | 10000 | 7.8 | C | 16 | Not | C | 3.5 | 92 |
| | | | | | | | | | peeled | | | |
| Example 2-7 | D | 2 | CMC | 53.4 | 10000 | 7.8 | D | 17 | Not | D | 3.6 | 92 |
| | | | | | | | | | peeled | | | |
| Example 2-8 | E | 2 | CMC | 54.1 | 10000 | 8.2 | E | 17 | Not | E | 3.6 | 92 |
| | | | | | | | | | peeled | | | |
| Example 2-9 | F | 2 | CMC | 53.7 | 10000 | 7.8 | F | 16 | Not | F | 3.8 | 92 |
| | | | | | | | | | peeled | | | |
| Example 2-10 | G | 2 | CMC | 53.9 | 10000 | 7.8 | G | 16 | Not | G | 3.5 | 91 |
| | | | | | | | | | peeled | | | |
| Example 2-11 | H | 2 | CMC | 53.5 | 10000 | 7.9 | H | 18 | Not | H | 3.5 | 93 |
| | | | | | | | | | peeled | | | |
| Example 2-12 | I | 2 | CMC | 53.4 | 10000 | 7.9 | I | 16 | Not | I | 3.6 | 90 |
| | | | | | | | | | peeled | | | |
| Example 2-13 | J | 2 | CMC | 53.5 | 10000 | 8.0 | J | 15 | Not | J | 3.8 | 89 |
| | | | | | | | | | peeled | | | |
| Example 2-14 | K | 2 | CMC | 53.3 | 10000 | 7.7 | K | 15 | Not | K | 3.5 | 88 |
| | | | | | | | | | peeled | | | |
| Example 2-15 | L | 2 | CMC | 53.1 | 10000 | 8.0 | L | 15 | Not | L | 3.7 | 91 |
| | | | | | | | | | peeled | | | |
| Example 2-16 | M | 2 | CMC | 53.4 | 10000 | 8.1 | M | 18 | Not | M | 3.8 | 92 |
| | | | | | | | | | peeled | | | |
| Example 2-17 | N | 2 | CMC | 53.5 | 10000 | 8.0 | N | 15 | Not | N | 3.5 | 91 |
| | | | | | | | | | peeled | | | |
| Example 2-18 | O | 2 | CMC | 53.2 | 10000 | 8.0 | O | 15 | Not | O | 3.5 | 89 |
| | | | | | | | | | peeled | | | |
| Comparative | P | 2 | CMC | 53.7 | 6000 | 7.8 | P | 9 | Peeled | P | 4.9 | 65 |
| Example 2-1 | | | | | | | | | | | | |
| Comparative | Q | 2 | CMC | 52.9 | 10000 | 8.2 | Q | 9 | Peeled | Q | 3.7 | 65 |
| Example 2-2 | | | | | | | | | | | | |
| Comparative | R | 2 | CMC | 53.3 | 10000 | 7.9 | R | 5 | Peeled | R | 3.7 | 60 |
| Example 2-3 | | | | | | | | | | | | |
| Comparative | S | 2 | CMC | 53.2 | 10000 | 7.7 | S | 15 | Peeled | S | 3.8 | 70 |
| Example 2-4 | | | | | | | | | | | | |
| Comparative | T | 2 | CMC | 54.0 | 10000 | 7.9 | T | N.D. | N.D. | T | N.D. | N.D. |
| Example 2-5 | | | | | | | | | | | | |
| Comparative | U | 2 | CMC | 53.3 | 10000 | 8.1 | U | 9 | Peeled | U | 3.8 | 66 |
| Example 2-6 | | | | | | | | | | | | |
| Comparative | V | 2 | CMC | 53.5 | 10000 | 8.1 | V | 15 | Peeled | V | 3.7 | 85 |
| Example 2-7 | | | | | | | | | | | | |
| Comparative | W | 2 | CMC | 53.5 | 10000 | 8.0 | W | 15 | Not | W | 5.0 | 60 |
| Example 2-8 | | | | | | | | | peeled | | | |
| Comparative | X | 2 | CMC | 53.2 | 10000 | 7.9 | X | 9 | Peeled | X | 3.7 | 61 |
| Example 2-9 | | | | | | | | | | | | |
| Comparative | Y | 2 | CMC | 53.5 | 10000 | 7.7 | Y | N.D. | N.D. | Y | N.D. | N.D. |
| Example 2-10 | | | | | | | | | | | | |
| Comparative | Z | 2 | CMC | 53.5 | 10000 | 7.9 | Z | 12 | Peeled | Z | 4.8 | 72 |
| Example 2-11 | | | | | | | | | | | | |

### Example 2-1

The preparation of the positive electrode will be described. To a mixture of 90% by mass of LiCoO₂, 5% by mass of acetylene black as a conductive assistant, and 5% by mass of polyvinylidene fluoride as a binder, 100% by mass of N-methyl pyrrolidone was added and further mixed to prepare a slurry for a positive electrode. The obtained slurry for a positive electrode was applied onto an aluminum foil having a thickness of 20 μm which was a current collector by a doctor blade method so that the thickness was 100 μm after roll press processing and dried at 120° C. for 5 minutes. Then, through a press process, a positive electrode was obtained.

The preparation of the negative electrode will be described. 100 Parts by mass of graphite (SCMG-BR-Om, manufactured by SHOWA DENKO K.K) as an active material, 2 parts by mass of acetylene black as a conductive assistant, and 1 part by mass of carboxymethyl cellulose-sodium salt (product name: SUNROSE MAC500LC, manufactured by NIPPON PAPER INDUSTRIES CO LTD.) as a thickener were weighed. To the weighed active materials, a small amount of water was added and the mixture was subjected to solid kneading using a stirring type mixing apparatus (planetary mixer) at 60 revolutions/minute for 20 minutes. Next, 2 parts by mass of the binder dispersion A as a binder with respect to 100 parts by mass of graphite added in advance was added and water was added so that the total mass of the mixture added in advance and water became 105 parts by mass with respect to the total 105 parts by mass of the graphite, acetylene black, carboxymethyl cellulose-sodium salt, and the binder dispersion. The components were further mixed at 60 revolutions/minute for 20 minutes to prepare a slurry for a negative electrode.

The obtained slurry for a negative electrode was applied onto one surface of a copper foil having a thickness of 18 μm which became a current collector using a doctor blade so that the amount of the slurry applied after drying was 7 mg/cm². The slurry was dried by heating at 60° C. for 10 minutes and then further dried at 120° C. for 10 minutes to form an active material layer. Thereafter, a negative electrode A1 of the present invention was obtained through a pressing process at a pressing pressure of 2 t/cm² using mold pressing.

The adjustment of the electrolytic solution will be described. Ethylene carbonate (EC) and diethyl carbonate (EMC) were mixed at a volume ratio of 40:60. In the mixed solvent, LiPF₆ was dissolved so that the concentration was 1.0 mol/L and thus the electrolytic solution was adjusted.

The preparation of the battery will be described. Conductive tabs were provided to the positive electrode and the negative electrode and a separator made of an polyolefin-based porous film was interposed between the positive electrode and the negative electrode. These components were housed in an aluminum laminate exterior body (battery pack) such that the active materials of the positive electrode and the negative electrode faced to each other. The electrolytic solution was injected into the exterior body and the exterior body was packed with a vacuum heat sealer. Then, a single layer laminate type battery A1, the negative electrode of which was the electrode of the present invention, was obtained.

### Example 2-2 to 2-4

Negative electrodes A2 to A4 and batteries A2 to A4 were obtained in the same manner as in Example 2-1, except that the type of the thickening material and the amount of the binder dispersion used were changed as shown in Table 11.

The thickeners in Table 11 are respectively shown below.

CMC: Carboxymethyl cellulose-sodium salt (product name: SUNROSE MAC500LC, manufactured by NIPPON PAPER INDUSTRIES CO., LTD.)

PAa: Sodium polyacrylate

NVA-Aa: N-Vinylacetamide-sodium acrylate copolymer

### Examples 2-5 to 2-18, Comparative Examples 2-1 to 2-11

Negative electrodes B to Z and batteries B to Z were obtained in the same manner as in Example 2-1, except that the binder dispersions B to Z were used in instead of the binder dispersion A.

From the comparison of Examples 2-1 to 2-18 and Comparative Examples 2-1 to 2-11 shown in Tables 1 to 11, it was found that the electrodes A1 to O each of which was composed of an active material layer formed by using the slurry including any one of the binders A to O and a metal foil had favorable peeling strength and when the electrode was cut, the active material layer was not easily peeled off. It was also found that the batteries A1 to O including the electrodes A1 to O had a low resistance and high service life characteristics in charge and discharge cycles.

In contrast, in Comparative Example 2-1, since the electrode P was formed by using the slurry including the binder P not containing the N atom-containing ethylenically unsaturated monomer, the peeling strength was not sufficient and when the electrode was cut, the active material layer was peeled off. Therefore, the battery P in Comparative Example 2-1 had a high resistance and low charge and discharge cycle characteristics.

In Comparative Example 2-2, since the electrode Q was formed by using the slurry including the binder Q containing a large amount of N atom-containing ethylenically unsaturated monomer, the peeling strength was not sufficient and when the electrode was cut, the active material layer was peeled off. Therefore, the battery Q in Comparative Example 2 had low charge and discharge cycle characteristics.

In Comparative Example 2-3, since the electrode T was formed by using the slurry including the binder R containing a small amount of styrene and a large amount of another ethylenically unsaturated monomer, the peeling strength was not sufficient and when the electrode was cut, the active material layer was peeled off. Therefore, the battery R in Comparative Example 2-3 had low charge and discharge cycle characteristics.

In Comparative Example 2-4, since the electrode S was formed by using the slurry including the binder S containing a large amount of styrene and a small amount of another ethylenically unsaturated monomer and having a high glass transition temperature, the active material layer was peeled off when the electrode was cut. Therefore, the battery S in Comparative Example 2-4 had low charge and discharge cycle characteristics.

In Comparative Example 2-5, the preparation of an electrode using the slurry including the binder T not containing ethylenically unsaturated carboxylic acid was attempted. However, the slurry was poorly dispersed and thus an electrode could not be formed.

In Comparative Example 2-6, since the electrode U was formed by using the slurry including the binder U containing a large amount of ethylenically unsaturated carboxylic acid, the peeling strength was not sufficient and when the electrode was cut, the active material layer was peeled off. Therefore, the battery U in Comparative Example 2-6 had low charge and discharge cycle characteristics.

In Comparative Example 2-7, since the electrode V was formed by using the slurry including the binder V having a high glass transition temperature, the active material layer was peeled off when the electrode was cut.

In Comparative Example 2-8, since the electrode W was formed by using the slurry including the binder W not containing the internal crosslinking agent, the battery V including the electrode had a high resistance and low charge and discharge cycle characteristics.

In Comparative Example 2-9, since the electrode X was formed by using the slurry including the binder X containing a large amount of the internal crosslinking agent, the peeling strength was not sufficient and when the electrode was cut, the active material layer was peeled off. Therefore, the battery X in Comparative Example 2-9 had low charge and discharge cycle characteristics.

In Comparative Example 2-10, the formation of the electrode Y using the slurry including the binder Y containing a small amount of styrene was attempted. However, the slurry was poorly dispersed and thus an electrode could not be formed.

In Comparative Example 2-11, since the electrode Z was formed by using the slurry including the binder Z having a high glass transition temperature, the peeling strength was not sufficient and the electrode was cracked. Therefore, the battery Z in Comparative Example 2-11 had a high resistance and low charge and discharge cycle characteristics.

1. A binder for a lithium ion secondary battery electrode that is obtained by emulsion polymerization of an ethylenically unsaturated monomer in an aqueous medium in the presence of a surfactant, the ethylenically unsaturated monomer being composed, with respect to the total mass of the ethylenically unsaturated monomer, of 15% by mass to 70% by mass of styrene, 1% by mass to 10% by mass of an N atom-containing ethylenically unsaturated monomer, 1% by mass to 10% by mass of an ethylenically unsaturated carboxylic acid, 0.1% by mass to 5% by mass of an internal crosslinking agent, and 22% by mass to 82.9% by mass of another ethylenically unsaturated monomer that is copolymerizable with these substances, and has a glass transition temperature of −55° C. to 30° C.

2. The binder for a lithium ion secondary battery electrode according to claim 1,
wherein the N atom-containing ethylenically unsaturated monomer is at least one unsaturated monomer selected from (meth)acrylamide, N-alkyl(meth)acrylamide having 1 to 4 carbon atoms in the alkyl group, N,N-dialkyl(meth)acrylamide having 1 or 2 carbon atoms in the alkyl group, N-hydroxyalkyl(meth)acrylamide having 1 or 2 carbon atoms in the alkyl group, diacetone(meth)acrylamide, and dimethylaminoalkyl(meth)acrylamide having 1 to 4 carbon atoms in the alkyl group in a moiety excluding the dimethylamino group, and (meth)acrylamide-2-methyl propane sulfonic acid or (meth)acrylamide ethyl ethylene urea.

3. The binder for a lithium ion secondary battery electrode according to claim 1,
wherein the ethylenically unsaturated carboxylic acid is at least one of unsaturated monocarboxylic acids selected from the group consisting of acrylic acid, methacrylic acid, and crotonic acid, and unsaturated dicarboxylic acids selected from the group consisting of maleic acid, fumaric acid, and itaconic acid, and half esters of the unsaturated dicarboxylic acids.

4. A slurry for a lithium ion secondary battery electrode comprising:
the binder for a lithium ion secondary battery electrode according to claim 1;
an active material; and
an aqueous medium.

5. The slurry for a lithium ion secondary battery electrode according to claim 4, further comprising
carboxymethyl cellulose.

6. An electrode for a lithium ion secondary battery that is formed by using the slurry for a lithium ion secondary battery electrode according to claim 4.

7. A lithium ion secondary battery comprising
the electrode for a lithium ion secondary battery according to claim 6.
